(19) United States
(12) Patent Application Publication
(10) Pub. No.: US 2013/0337300 A1
(43) Pub. Date: Dec. 19, 2013

(54) SECONDARY BATTERY

(71) Applicant: Mamoru Saito, Kanagawa (JP)

(72) Inventor: Mamoru Saito, Kanagawa (JP)

(73) Assignee: NEC ENERGY DEVICES, LTD., Kanagawa (JP)

(21) Appl. No.: 14/001,438

(22) PCT Filed: Feb. 28, 2012
(86) PCT No.: PCT/JP2012/054995

§ 371 Date: Aug. 23, 2013

(30) Foreign Application Priority Data
Mar. 30, 2011 (JP) 2011-075545

(51) Int. Cl. H01M 2/34

(52) U.S. Cl. CPC H01M 2/345
USPC 429/61

(57) ABSTRACT

The present invention includes: electrode layered assembly (6) having a cathode and an anode which are layered via a separator; external case (7) for housing electrode layered assembly (6); an anode tab in which one end is electrically connected to the anode and the other end extends to the outside of external case (7); and unit (10) for interrupting the flow of excess current having element (11) for interrupting the flow of excess current, said element being located on a current path between the anode and the anode tab. Element (11) for interrupting the flow of excess current includes a set of breaker units (16) which are connected to an inner surface facing external case (7) and which are broken when external case (7) expands, and blowout unit (17) which is formed astride the set of breaker units (16) and which is blown when excess current flows. One of the set of breaker units (16) is electrically connected to the anode tab, and the other of the set of breaker units (16) is electrically connected to the anode.

### TECHNICAL FIELD

The present invention relates to a secondary battery configured by housing an electrode layered assembly which has a cathode and an anode that are layered via a separator in an external case.

### BACKGROUND ART

As a secondary battery, there is known a laminated secondary battery configured by housing an electrode layered assembly in which a cathode and an anode are layered via a separator interposed therebetween in an external case. From the standpoint of battery safety, the secondary battery of this type needs a structure that quickly interrupts current at the time of external short-circuiting when external terminals short-circuit and at the time of overcharging a fully charged battery.

Concerning the structure that interrupts current at the time of overcharging, Patent

Literature 1 discloses a configuration that includes an internal flat-plate terminal disposed in the external case and an external flat-plate terminal which has one end that protrudes from the inside of the external case, and one end of the internal terminal that is connected to the other end of the external terminal. In this configuration, when the internal pressure of the external case rises due to gas generated at the time of overcharging, the connected portion of the internal terminal and the external terminal is peeled off to interrupt the current.

Concerning the structure that interrupts current at the time of external short-circuiting, Patent Literature 2 discloses a configuration that has a fuse structure in the external terminal. In this configuration, the fuse structure blows, due to the flow of excess current when an external short circuit occurs, to interrupt the current.

### CITATION LIST

Patent Literature 1: JP2005-044523A

Patent Literature 2: JP2008-177084A

### SUMMARY OF INVENTION

However, in the structure that interrupts the flow of excess current described in Patent Literature 1, the flow of current is not interrupted in the case where the generation of gas does not cause an increase in the internal pressure of the external case. Therefore, this structure is not effective for interrupting the flow of excess current caused by an external short circuit.

The structure that interrupts the flow of excess current described in Patent Literature 2 can deal with the excess current generated by the external short-circuiting. However, in the structure that interrupts the flow of excess current described in Patent Literature 2, since no large current flows at the time of overcharging, the fuse structure does not blow, nor can the flow of excess current be interrupted.

As a result, in the configurations described in Patent Literatures 1 and 2, there is a problem in which battery safety cannot be ensured both at the time when an external short circuit occurs and at the time of battery overcharge.

It is therefore an object of the present invention to provide a secondary battery capable of solving the problems of the related technologies. As an example, the present invention provides a secondary battery capable of ensuring battery safety both at the time of external short-circuiting and at the time of overcharging by the use of a single element that interrupts the flow of excess current.

To achieve the object, a secondary battery according to the present invention includes: an electrode layered assembly having a cathode and an anode which are layered via a separator; an external case for housing the electrode layered assembly; an electrode terminal in which one end is electrically connected to the cathode or the anode and the other end extends to the outside of the external case; and a unit for interrupting the flow of excess current having a element for interrupting the flow of excess current, said element being located on a current path between the cathode or the anode and the electrode terminal. The element for interrupting the flow of excess current includes a set of breaker units which are connected to an inner surface facing the external case and which are broken when the external case expands, and a blowout unit which is formed astride the set of breaker units and which is blown when excess current flows. One of the set of breaker units is electrically connected to the electrode terminal, and the other of the set of breaker units is electrically connected to the cathode or the anode.

According to the present invention, since the element for interrupting the flow of excess current includes the blowout unit and the breaker units, battery safety can be increased both at the time of external short-circuiting and at the time of overcharging by using the single element for interrupting the flow of excess current

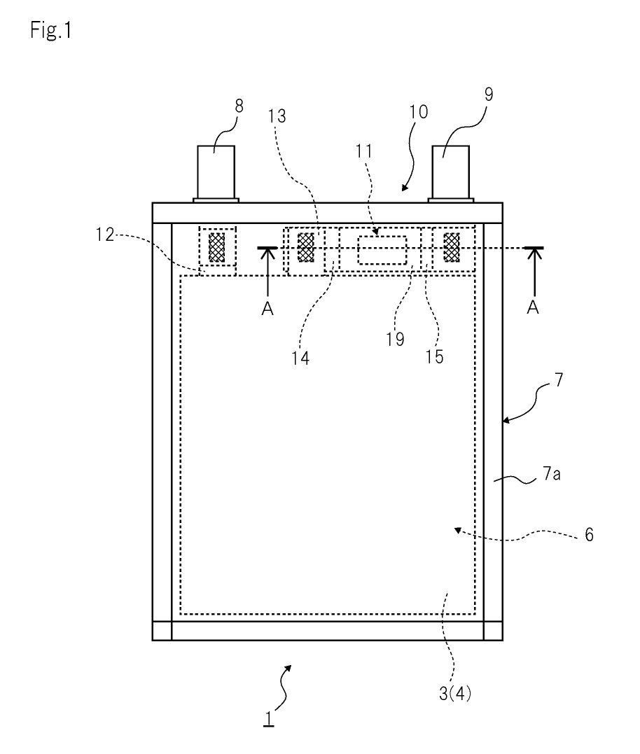

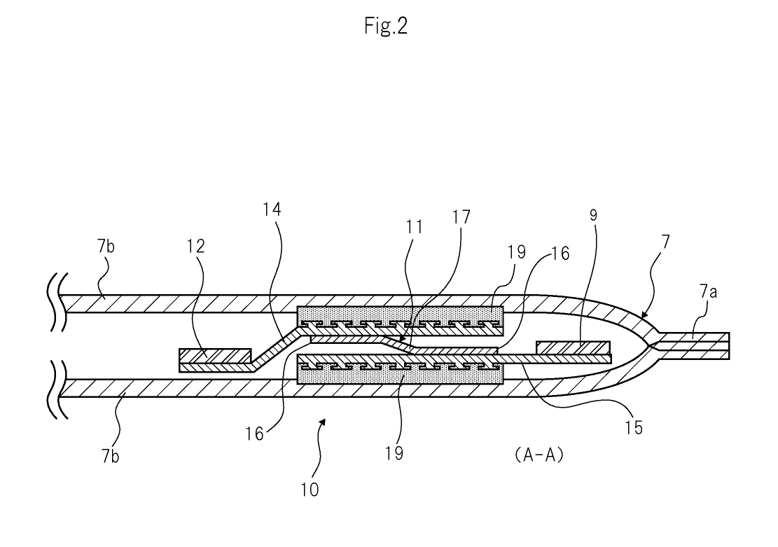

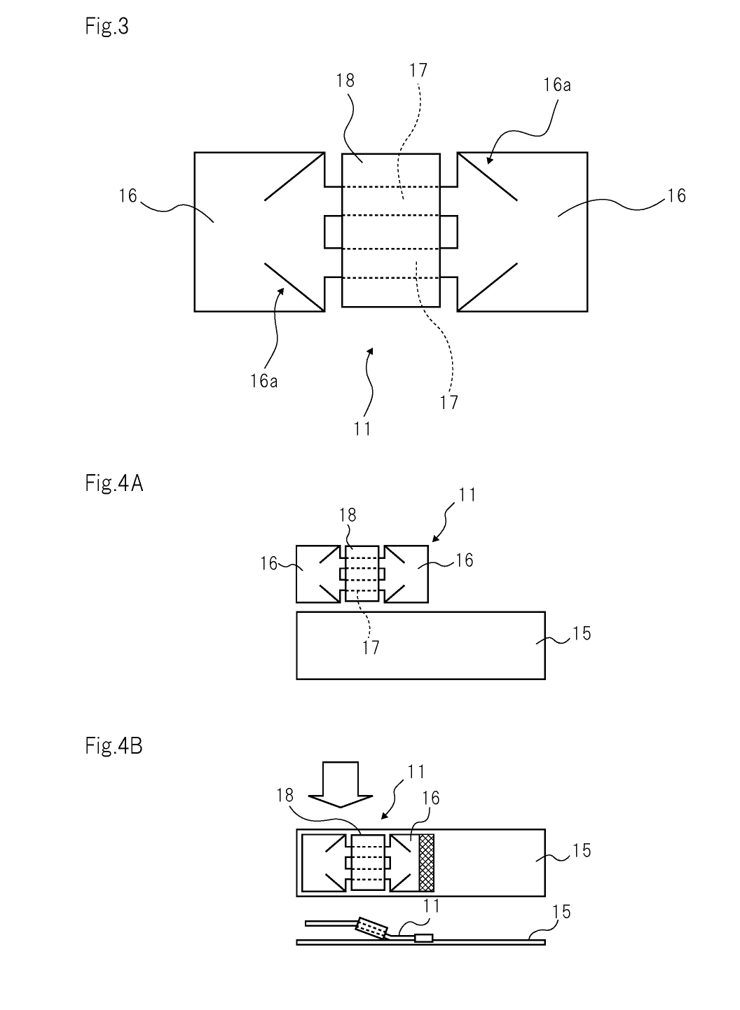

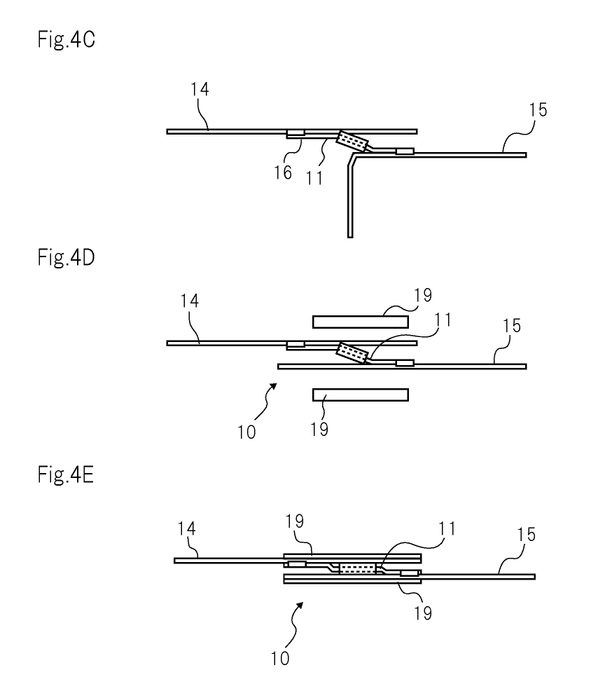

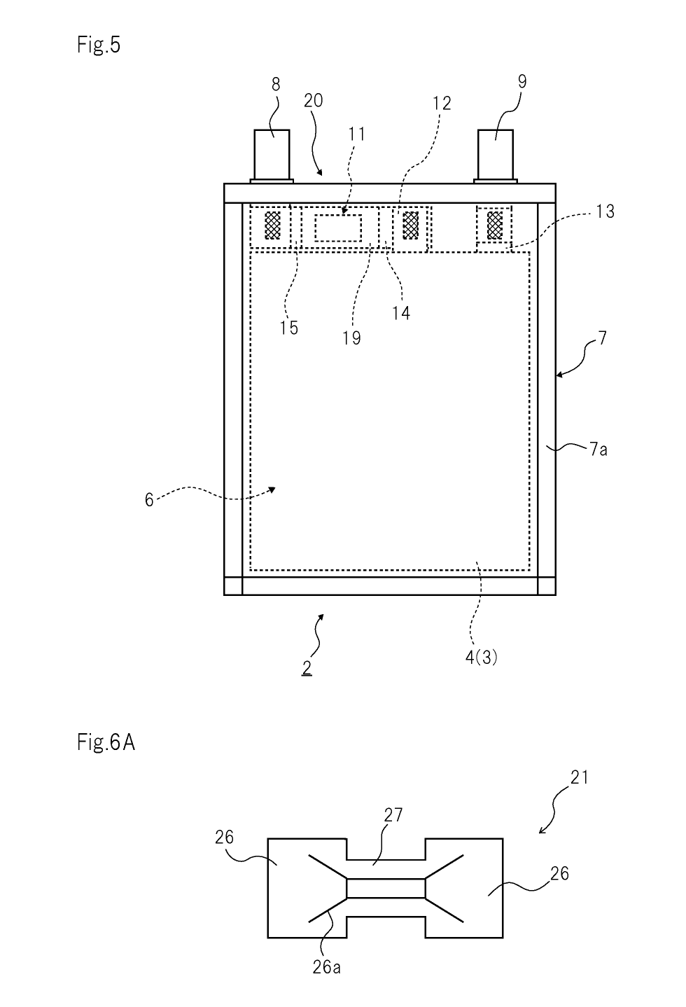

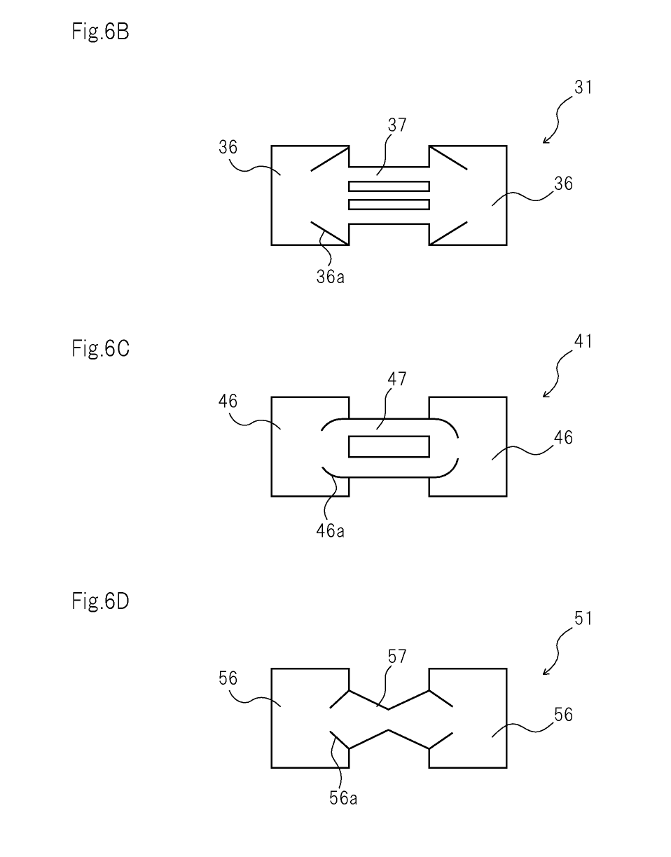

### BRIEF DESCRIPTION OF DRAWINGS

[FIG. 1] A perspective plane view showing a laminated secondary battery according to a first embodiment.

[FIG. 2] A sectional view cut along the line A-A shown in FIG. 1 showing the unit for interrupting the flow of excess current of the laminated secondary battery according to the first embodiment.

[FIG. 3] A plane view showing a element for interrupting the flow of excess current included in the laminated secondary battery according to the first embodiment.

[FIG. 4A] An explanatory view showing the manufacturing process of the unit for interrupting the flow of excess current according to the first embodiment.

[FIG. 4B] An explanatory view showing the manufacturing process of the unit for interrupting the flow of excess current according to the first embodiment.

[FIG. 4C] An explanatory view showing the manufacturing process of the unit for interrupting the flow of excess current according to the first embodiment.

[FIG. 4D] An explanatory view showing the manufacturing process of the unit for interrupting the flow of excess current according to the first embodiment.

[FIG. 4E] An explanatory view showing the manufacturing process of the unit for interrupting the flow of excess current according to the first embodiment.

[FIG. 5] A perspective plane view showing a laminated secondary battery according to a second embodiment.

[FIG. 6A] A plane view showing the configuration example of the element for interrupting the flow of excess current according to the embodiment.

[FIG. 6B] A plane view showing the configuration example of the element for interrupting the flow of excess current according to the embodiment.

[FIG. 6C] A plane view showing the configuration example of the element for interrupting the flow of excess current according to the embodiment.

[FIG. 6D] A plane view showing the configuration example of the element for interrupting the flow of excess current according to the embodiment.

### DESCRIPTION OF EMBODIMENTS

The specific embodiments of the present invention will be described with reference to the drawings.

### First Embodiment

FIG. 1 is a perspective plane view showing a laminated secondary battery according to a first embodiment. FIG. 2 is a sectional view cut along the line A-A shown in FIG. 1 showing the unit for interrupting the flow of excess current of the laminated secondary battery according to the first embodiment.

As shown in FIG. 1, laminated secondary battery 1 according to the first embodiment, which is configured as a lithium ion secondary battery, includes electrode layered assembly 6 formed by alternately layering sheet-shaped cathodes 3 and sheet-shaped anodes 4 via a separator (not shown). Cathode 3 has cathode active material which is formed on at least one surface of cathode collector foil 12, and anode 4 has anode active material which is formed on at least one surface of anode collector foil 13. Hereinafter, for convenience, a portion having cathode active material which is formed on at least one surface of the cathode collector foil will be simply referred to as a cathode, and a portion having anode active material which is formed on at least one surface of the anode collector foil will be simply referred to as an anode. In the cathode collector foil and the anode collector foil, there are portions that do not have any active material on both surfaces. The portions similar in polarity are connected by ultrasonic welding or the like to form a parallel structure. However, for convenience, the portions of the cathode collector foil that do not have any active material on both surfaces will be simply referred to as cathode collector foil collectively. The portions of the anode collector foil that do not have any active material on both surfaces will be simply referred to as anode collector foil collectively.

Laminated secondary battery 1 includes external case 7 that covers electrode layered assembly 6, cathode tab 8 and anode tab 9 as a set of electrode terminals in which one end is electrically connected to cathode 3 and anode 4 and the other end extends to the outside of external case 7, and unit 10 for interrupting the flow of excess current that has element 11 for interrupting the flow of excess current which is located on a current path between anode 4 and anode tab 9.

As shown in FIG. 1, cathode collector foil 12 is located at the outer edge of cathode 3, and one end of cathode tab 8 is connected to cathode collector foil 12. Similarly, as shown in FIGS. 1 and 2, anode collector foil 13 is located at the outer edge of anode 4, and unit 10 for interrupting the flow of excess current is located astride anode collector foil 13 and anode tab 9.

As shown in FIG. 2, external case 7 includes a set of external casing portions 7b facing each other with electrode layered assembly 6 sandwiched therebetween. The set of external casing portions 7b is made of film-shaped aluminum, and is formed into a bag shape by forming a weld portion 7a welded on the outer peripheral portion.

As shown in FIGS. 1 and 2, current interrupt unit 10 includes element 11 for interrupting the flow of excess current, first belt-like conductor 14 having one end connected to anode collector foil 14 and the other end connected to element 11 for interrupting the flow of excess current, and second belt-like conductor 15 in which one end is connected to element 11 for interrupting the flow of excess current and the other end is connected to anode tab 9.

FIG. 3 is a plane view showing element 11 for interrupting the flow of excess current which is included in laminated secondary battery 1 according to the first embodiment. Element 11 for interrupting the flow of excess current is formed into a metallic foil shape by a metallic material such as aluminum. As shown in FIG. 3, element 11 for interrupting the flow of excess current includes a set of breaker units 16 which are connected to the set of external casing portions 7b of external case 7, and two blowout units 17 which are formed into belt shapes astride the set of breaker units 15. In element 11 for interrupting the flow of excess current, one end of the set of breaker units 16 is electrically connected to anode tab 9, and the other of the set of breaker units 16 is electrically connected to anode 4.

Breaker unit 16, which is formed into a square shape, includes two breaks 16a linearly extending from two corners adjacent to blowout unit 17 toward the center. Breaker unit 16 is mechanically broken along breaks 16a due to movement of the set of external casing portions 7b in a separating direction when gas pressure generated at the time of overcharging causes expansion of external case 7. The end of breaker unit 16 is connected to first and second conductors 14 and 15 by using, for example, ultrasonic welding or laser welding.

Blowout unit 17 is integrally formed astride the set of breaker units 16 with a predetermined welding width and a predetermined sectional area at a desired temperature. As shown in FIG. 3, blowout unit 17 is covered with heat insulating tape 18 serving as a heat insulating member to protect the end of breaker unit 16 from heat generated when it is welded to first and second conductors 14 and 15.

In other words, element 11 for interrupting the flow of excess current includes breaker unit 16 which is activated by the expansion of external case 7 at the time of overcharging, and blowout unit 17 which is activated by excess current at the time of short-circuiting of cathode 3 and anode 4.

As shown in FIG. 2, the other end of first conductor 14 is connected to the inner surface of one external casing portion 7b via connection plate 19. One end of second conductor 15 is connected to the inner surface of other external casing portion 7b via connection plate 19. Connection plate 19, which is formed larger than the outer shape of element 11 for interrupting the flow of excess current by a polypropylene resin, has one surface of a thickness direction welded to the inner surface of external casing portion 7b. Connection plate 19 has the other surface of the thickness direction welded to the ends of first and second conductors 14 and 15 where rough surfaces are formed. In the embodiment, the first and second conductors are connected to both ends of the element for interrupting the flow of excess current. However, portions corresponding to first and second conductors 14 and 15 can be integrally formed at both ends of element 11 for interrupting the flow of excess current.

For laminated secondary battery 1 thus configured, the operation state of unit 10 for interrupting the flow of excess current will be described.

In unit 10 for interrupting the flow of excess current, when electric contact or the like between cathode tab 8 and anode tab 9 causes external short-circuiting of cathode 3 and anode 4, excess current flows through blowout unit 17 of element 11 for interrupting the flow of excess current to blowout unit 17. As a result, electric conduction between first conductor 14 and second conductor 15 is cut off.

In unit 10 for interrupting the flow of excess current, when laminated secondary battery 1 is overcharged, gas is generated in external case 7 to cause external case 7 to expand. The expansion of external case 7 is accompanied by movement of external casing portion 7b in a separating direction, thus applying tension to breaker unit 16 of element 11 for interrupting the flow of excess current. This tension causes quick breakage of the set of breaker units 16 along two breaks 16a. Thus, electric conduction between first conductor 14 and second conductor 15 is cut off.

Next, the manufacturing process of unit 10 for interrupting the flow of excess current according to the first embodiment will be described. FIGS. 4A to 4E illustrate the manufacturing process of unit 10 for interrupting the flow of excess current according to the first embodiment.

As shown in FIG. 4A, heat insulating tape 18 is wound on blowout unit 17 of element 11 for interrupting the flow of excess current. Then, as shown in FIGS. 4A and 4B, the end of one breaker unit 16 of element 11 for interrupting the flow of excess current is welded to the end of second conductor 15.

Then, as shown in FIG. 4C, the end of other breaker unit 16 of element 11 for interrupting the flow of excess current is welded to the end of first conductor 14. Accordingly, element 11 for interrupting the flow of excess current is connected astride first conductor 14 and second conductor 15 in the state of being located between the end of first conductor 14 and the end of second conductor 15.

Then, as shown in FIGS. 4D and 4E, a rough surface is formed on the surface of the outside of first conductor 14 and second conductor 15 sandwiching element 11 for interrupting the flow of excess current, and connection plate 19 is welded to the surface of the outside. Thus, the ends of first and second conductors 14 and 15 are held between the set of connection plates 19.

Lastly, the set of connection plates 19 is connected to the inner surface of external casing portion 7b of external case 7 to constitute unit 10 for interrupting the flow of excess current.

As described above, according to laminated secondary battery 1 according to the first embodiment, element 11 for interrupting the flow of excess current includes breaker unit 16 and blowout unit 17. Thus, battery safety can be enhanced both at the time of external short-circuiting and at the time of overcharging by using single element 11 for interrupting the flow of excess current.

According to the embodiment, current can be interrupted both at the time of external short-circuiting and at the time of overcharging only by using single element 11 for interrupting the flow of excess current. Thus, as compared with a structure using two types of elements for interrupting the flow of excess current in combination, the embodiment can simplify the structure of laminated secondary battery 1 and can simplify the manufacturing process and can prevent on increase in the size of the secondary battery.

### Second Embodiment

FIG. 5 is a perspective plane view showing a laminated secondary battery according to a second embodiment. The laminated secondary battery of the second embodiment is different from that of the first embodiment in that a unit for interrupting the flow of excess current is disposed on a current path of a cathode tab and a cathode. The second embodiment is similar in configuration to the first embodiment except for the position of the unit for interrupting the flow of excess current. Thus, components similar to those of the first embodiment will be denoted by similar reference numerals, and description thereof will be omitted.

As shown in FIG. 5, laminated secondary battery 2 of the second embodiment includes unit 20 for interrupting the flow of excess current which is located on the current path of the cathode tab and the cathode. The configuration and the operation of unit 20 for interrupting the flow of excess current are similar to those of unit 10 for interrupting the flow of excess current of the first embodiment.

In the laminated secondary battery of the second embodiment thus configured, the same effects as those of the first embodiment can be provided by including unit 20 for interrupting the flow of excess current.

For laminated secondary batteries 1 and 2 of the first and second embodiments, an external short-circuiting test and an overcharging test were conducted. In the external short-circuiting test and the overcharging test, the first embodiment in which the unit for interrupting the flow of excess current was located between the anode and the anode tab, the second embodiment in which the unit for interrupting the flow of excess current was located between the cathode and the cathode tab, and a comparative example including no unit for interrupting the flow of excess current were compared with one another. The external short-circuiting test and the overcharging test were conducted by the following procedure.

(External Short-circuiting Test)

(1) The battery is set in an overcharged state of “DOD (Depth of discharge): 0%”

(2) The temperature is stabilized so that the surface temperature of the battery can be “20° C.±2° C.”

(3) The battery is set in an externally short-circuited state by using external resistance of “less than totally 0.1Ω”, and the short-circuited state is continued for 1 hour.

(Overcharging Test)

(1) The battery is set in a discharged state of “DOD: 100%”

(2) Charging is continued for 2.5 hours under the condition of 10 V-1 C.

TABLE 1

| | Presence of | | External short- | | | | |
|---|---|---|---|---|---|---|---|
| | element for | | circuiting test | | Overcharging test | | |
| | interrupting the | | Presence | | Presence | | |
| | flow of excess | | of fire | | of fire | Presence | |
| | current | | and | Surface | and | of liquid | |
| | Anode | Cathode | smoke | Temperature | smoke | leakage | Determination |
| First | Yes | No | No | 55° C. | No | No | ◯ |
| embodiment | | | | | | | |
| Second | No | Yes | No | 56° C. | No | No | ◯ |
| embodiment | | | | | | | |
| Comparative | No | No | No | 140° C. | No | Yes | Δ |
| example | | | | | | | |

Table 1 shows the results of the first embodiment, the second embodiment, and the comparative example. As shown in Table 1, in the case of the laminated secondary battery including the element for interrupting the flow of excess current, similar effects can be obtained in the first and second embodiments, and battery safety is enhanced irrespective of the position of the element for interrupting the flow of excess current compared with the comparative example.

Lastly, the other configuration example of the element for interrupting the flow of excess current will be described. FIGS. 6A to 6D are plane views each showing the configuration example of the element for interrupting the flow of excess current according to the embodiment. The element for interrupting the flow of excess current of the other configuration example is disposed in unit 10 for interrupting the flow of excess current as in the case of aforementioned element 11 for interrupting the flow of excess current. Thus, only the difference in shape of the element for interrupting the flow of excess current will be described.

As shown in FIG. 6A, element 21 for interrupting the flow of excess current includes a set of breaker units 26 and two blowout units 27 integrally formed astride the set of breaker units 26. Breaker unit 26, which is formed into a square shape, includes two breaks 26a linearly extending from a corner between blowout units 27 toward the corner of the end side which is connected to first and second conductors 14 and 15. Element 21 for interrupting the flow of excess current is different from element 11 for interrupting the flow of excess current in the extending direction of break 26a.

As shown in FIG. 6B, element 31 for interrupting the flow of excess current includes a set of breaker units 36 and three blowout units 37 integrally formed astride the set of breaker units 36. Breaker unit 36, which is formed into a square shape, includes two breaks 36a which linearly extend from two corners adjacent to blowout units 37 toward the center. Three blowout units 37 include a plurality of types of blowout portions different in width. The total of sectional areas of three blowout units 37 orthogonal to a longitudinal direction is equal to that of the sectional areas of two blowout units 17 and 27 of aforementioned elements 11 and 21 for interrupting the flow of excess current. Thus, the number of blowout units 37 can be appropriately increased or decreased as occasion demands.

As shown in FIG. 6C, element 41 for interrupting the flow of excess current includes a set of breaker units 46 and two blowout units 47 which are formed astride the set of breaker units 46. Breaker unit 46 includes two breaks 46a which continuously extend from the side edge of belt-like blowout unit 47. Break 46a has the end of the center side of break unit 46 formed into a circular arc shape.

As shown in FIG. 6D, element 51 for interrupting the flow of excess current includes a set of breaker units 56 and includes one blowout unit 57 which is integrally formed astride the set of breaker units 56. Breaker unit 56 includes two breaks 56a which linearly extend continuously from the side edge of blowout unit 57 toward the center of breaker unit 56. Blowout unit 57 is roughly formed into a drum shape where the center width of the longitudinal direction is narrow, and a welding position is limited to the center of the longitudinal direction.

Element 21, 31, 41 and 51 for interrupting the flow of excess current thus configured can be operated as in the case of element 11 for interrupting the flow of excess current. The shape of element for interrupting the flow of excess current is not limited to the configuration example. When necessary in the structure of the laminated secondary battery, the extending direction and the length of the break and the shape of the blowout unit can be appropriately set. The breaker unit is not limited to the configuration including the breaks. Any structure can be adapted as long as the breaker unit is formed into a predetermined outer shape having a portion where stress concentrates by tension and as long as the breaker unit is quickly broken by the tension.

The secondary battery of the embodiment has been described by adapting the configuration example including the electrode layered assembly which is formed by layering the sheet-shaped cathode and the sheet-shaped anode via the separator. However, the secondary battery is not limited to this configuration. Needless to say, the secondary battery can be configured by including an electrode layered assembly which is formed by winding the cathode and the anode layered via the separator. In the embodiment, the sheet-shaped cathode and the sheet-shaped anode are connected in parallel. However, the present invention can be applied when they are connected in series.

The embodiments of the present invention have been described. However, the present invention is not limited to the embodiments. Various changes understandable to those skilled in by the art can be made to the configuration and the specifics of the present invention within the scope of the invention.

This application claims priority from Japanese Patent Application No. 2011-075545 filed Mar. 30, 2011, which is hereby incorporated by reference herein in its entirety.

1. A secondary battery comprising:
an electrode layered assembly which has a cathode and an anode that are layered via a separator;
an external case for housing the electrode layered assembly;
an electrode terminal in which one end is electrically connected to the cathode or the anode and the other end extends to the outside of the external case; and
a unit for interrupting the flow of excess current having a element for interrupting the flow of excess current, said element being located on a current path between the cathode or the anode and the electrode terminal,
wherein the element for interrupting the flow of excess current includes a set of breaker units which are connected to an inner surface facing the external case and which are broken when the external case expands, and a blowout unit which is formed astride the set of breaker units and which is blown when excess current flows, one of the set of breaker units being electrically connected to the electrode terminal, and the other of the set of breaker units being electrically connected to the cathode or the anode.

2. The secondary battery according to claim 1, wherein the unit for interrupting the flow of excess current includes a first conductor that connects one end of the element for interrupting the flow of excess current to the cathode or the anode, and a second conductor that connects the other end of the element for interrupting the flow of excess current to the electrode terminal.

3. The secondary battery according to claim 1, wherein the unit for interrupting the flow of excess current includes a heat insulating material which covers the blowout unit.

4. The secondary battery according to claim 1, wherein the breaker unit includes a plurality of breaks which extend from an outer edge.

5. The secondary battery according to claim 1, wherein the electrode layered assembly is configured by winding the cathode and the anode layered via the separator.
